(19) United States
(12) Patent Application Publication
(10) Pub. No.: US 2005/0006392 A1
(43) Pub. Date: Jan. 13, 2005

(54) Mechanical support system for devices operating at cryogenic temperature

(76) Inventor: Xing Yuan, Albany, NY (US)

Correspondence Address: George L. Rideout, Jr., 4400 Abbott Grove Drive, Crestwood, KY, 40014, US

(21) Appl. No.: 10/606,468

(22) Filed: Jun. 26, 2003

(51) Int. Cl. F17C 1/00

(52) U.S. Cl. 220/560.12

(57) ABSTRACT

A mechanical support mechanism for a device operating at cryogenic temperature where the cryogenic container vessel is situated within another larger container vessel. The apparatus provides means to secure the inner vessel to the outer vessel through a bottom-support component and a side-support component. These components consist of mating structures of different configurations that provide inner vessel with constraints for horizontal, lateral, vertical and rotational degrees of freedom while at the same time achieving minimal physical contacts between the inner and outer container vessels to reduce heat leak into the inner cryogenic container.

### BACKGROUND

The invention relates generally to a mechanical support system for devices that operate at cryogenic temperature.

Design of mechanical support systems for cryogenic systems such as those of high temperature superconductor (HTS) applications faces additional challenges compare to similar system for room temperature devices. One of these challenges is accommodating heat transfers from high temperature parts to lower temperature parts of the device. Without proper thermal insulation to insulate the cold part of the device from its warm temperature environment, there will be a substantial amount of heat leak into the cryogenic system, thereby generating a tremendous burden on the cryogenic cooling system of the device. Consequently, the mechanical support system for the cryogenic device should be designed to minimize the contacts between the warm part and the cold part of the device in order to minimize the heat leak resulting from these contacts. Another major challenge is the fact that materials experience severe thermal contraction at cryogenic temperature. Different materials experience different degrees of such thermal contraction. Therefore, the design of cryogenic mechanical support system must take into account the thermal contraction of the cold part of the device. The design must also accommodate proper material matching so that the difference in thermal contraction of various materials of the device don't result in high thermal stress in the device that exceeds what those materials can handle in the cryogenic environment.

One of the commonly used thermal insulation methods for a cryogenic system is to house the device in an outer vacuum vessel. FIG. 1 shows an example of such an approach. The inner vessel houses the cryogenic device and is at cryogenic temperature. The inner vessel could hold a liquid cryogen such as liquid nitrogen. It can also carry gaseous phase of a cryogen or the combination of both the liquid and gaseous phase of a cryogen. The inner vessel could also be pressurized to above one atmospheric pressure or to be maintained at a low pressure that is below one atmospheric pressure. The inner vessel is disposed inside an outer vessel that is maintained under vacuum. The vacuum provides a thermal barrier to the inner vessel and insulates it from the thermal conduction from the higher temperature environment outside the outer vacuum vessel. Materials such as multi-layer insulation (MLI) sheets can be used to warp around the inner vessel to reduce the radiation heat leak into the inner cryo vessel. The inner vessel is then suspended on the top plate of the outer vessel. The suspension-type of mechanical support system illustrated here puts the entire burden on the top plate of the outer vessel. Such a method would be very difficult to implement for a large and/or heavy inner vessel. It is also not very flexible. For example, to access the components between the top of the inner vessel and underneath the top supporting plate, the complete inner vessel needs to be lifted out of the outer vessel.

Therefore, for cryogenic systems that use aforementioned two-vessel approach to achieve high-quality thermal insulation, a more robust and versatile mechanical support system is desired. This is especially true for cases where inner vessel is large and/or heavy, and where easy access to the region between the two vessels are desired without lifting the inner vessel out of the outer housing, for purposes such as service and maintenance. Such a mechanical support system should not only be able to provide adequate mechanical support to a large and heavy inner vessel, but should also have minimal physical contact between the inner and outer containers to minimize the heat leak into the cryogenic system. It should also provide rigid and sufficient constraints on axial (horizontal, lateral, and vertical) and rotational (about the center vertical axis) movement of the inner container vessel, and to allow easy vertical lifting of the inner vessel without obstruction.

### BRIEF DESCRIPTION

Briefly, in accordance with one embodiment of the present invention, an apparatus is provided for securing an inner vessel having a bottom and a side wall onto an outer vessel having a bottom wall and a side wall, within a cryogenic system. The inner vessel is at cryogenic temperature while the outer vessel is at a higher temperature such as the room temperature. The outer vessel is sized to envelop the inner vessel, where a vacuum may be maintained in the space between the outer vessel and the inner vessel to provide thermal insulation. Both vessels are nominally concentric with each other relative to the vertical central axis.

The apparatus comprises at least one bottom-support component and at least one side-support component. The bottom-support component comprises at least one mating structure consisting of at least one pair of male adapter and female receptor. The male adapter (or the female receptor) is secured to the outside of the inner vessel bottom, and the female receptor (or the male adapter) is secured to the inside of the outer vessel bottom. In one embodiment, the mating structure prevents the inner vessel from rotational movement about the vertical central axis but will allow vertical lifting of the inner vessel. In another embodiment, both the male adapter or the female receptor has an “L” shaped section that creates a vertical locking structure to prevent the vertical movement of the inner vessel once the “L” sections are rotated into a locking position. This achieves the so-called “Twist-N-Lock” mating mechanism. In both cases, the horizontal and lateral movements of the inner vessel are constrained by such a bottom-support component of the apparatus.

The purpose of the side-support component of the apparatus is to provide additional constraints on those degrees of freedom that are not constrained by the bottom-support component of the apparatus. It can also provide redundant constraints on those degrees of freedom that have been addressed by the bottom-support. One embodiment of the side-support mating structure has one female receptor on both the inside of the outer vessel side wall and the outside of the inner vessel side wall. The mating is achieved by a pin-like structure disposed in the openings of the receptors and fastened on one or both ends. The alignment of the two receptors and the pin-like structure allows sufficient room for the radial contraction (about the center axis) of the inner vessel after it is cooled to cryogenic temperature, and provides radial constraint to the inner vessel once it becomes cold. Another embodiment consists of one male adapter mounted on the inside of the outer vessel side wall and one female receptor mounted on the outside of the inner vessel side wall (or vice versa). The pair is mated together either when the inner vessel is vertically dropped into place or when the inner vessel was rotated into a locking position at the bottom (the so-called “Twist-N-Lock” bottom-support mechanism). The pair can be fastened together to achieve sufficient degree of rigidity for the support and constraints it provides. The shape selection of the mating structure and the connecting structure take into account the contact surface of the interconnections to minimize the contacts between the elements of the structures. The material selection of these structural elements must also take into account the difference in thermal contraction once they experience different temperatures. Materials with poor thermal conductivity but good mechanical properties at cryogenic temperatures, such as G10 epoxy, may be used for part or all of the mechanical support apparatus.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a typical cryogenic system having an outer vessel and an inner vessel, and with top flange provides mechanical support of the inner vessel.

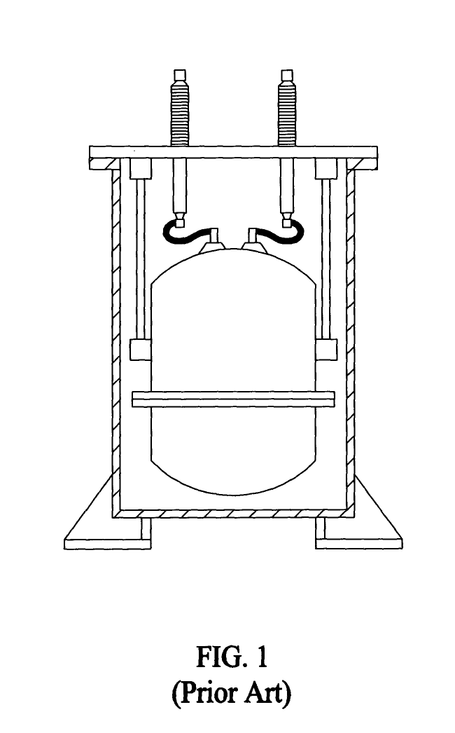

FIG. 2 is an illustration of the mechanical support apparatus of the present invention having at least one bottom-support component and at least one side-support component, in a two-vessel cryogenic system.

FIG. 3 is an illustration of a bottom-support component of the present invention. The component comprises three mating structures, each consists of one male adapter (a round peg) and one female receptor (a block peg support with a round slot).

FIG. 4 is an illustration of several configurations of the mating structure that can be part of the bottom-support component of the present invention.

FIG. 5 is an illustration of an “L” shaped bottom-support component of present invention and part of the “Twist-N-Lock” mechanism.

FIG. 6 is an illustration of one configuration of a side-support component of present invention having a mating structure secured to the sides of the inner and outer vessel.

FIG. 7 is an illustration of an alternate configuration of a mating structure of the side-support component shown in FIG. 6.

### DETAILED DESCRIPTION

The present invention is a mechanical support apparatus for a cryogenic device system in which one vessel that houses the device at cryogenic temperature is located within and secured onto another larger outer vessel that is maintained at higher temperature. Such a mechanical support mechanism provides constraints on rotational and planar movements of the inner container vessel, while at the same time achieving minimal physical contact between the inner and outer container vessels and allowing room for thermal contraction during the cool down of the inner vessel. The apparatus comprises at least one bottom-support component and at least one side-support component. Each of these components comprises at least one mating structure of various configurations and is affixed to the surfaces of the inner and outer container vessels by various means.

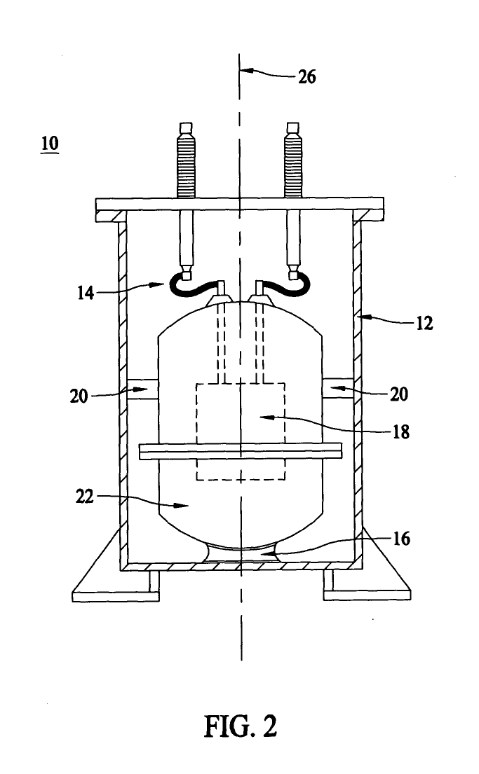

The present invention, as illustrated in FIG. 2, provides a mechanical support system 10 for the inner vessel 22 of a cryogenic device 18. An inner vessel 22 contains cryogen, in liquid or gaseous phase or combinations of both, and operates at cryogenic temperature. The vessel 22 is disposed within a larger outer vessel 12 that is maintained at a higher temperature than the temperature of inner vessel 22. The space 14 between the two vessels is maintained at a vacuum to provide thermal insulation. A mechanical support mechanism with at least one bottom-support component 16 and at least one side-support component 20 is used to support the weight of the inner vessel 22, and to provide constraints on rotational and planer (horizontal, lateral and vertical) degrees of freedom of the inner vessel 22. The two vessels 12 and 22 are approximately concentric about a central vertical axis 26. The rotational degrees of freedom represent rotational movements (clockwise or counter-clockwise) about the central vertical axis 26. The planer degree of freedom represents horizontal, lateral and vertical linear movements. The components of the mechanical support mechanism also enable outer vessel 12 to achieve minimal physical contact with inner vessel 22, to reduce heat leak into the cryogenic system.

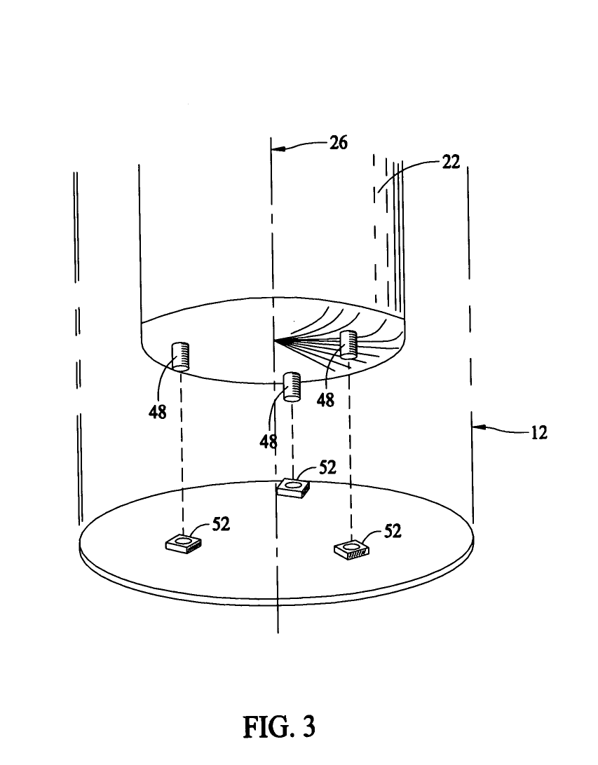

FIG. 3 is an illustration of a bottom-support component of the present invention. The component comprises three mating structures each consists of one male adapter (the round peg 48) and one female receptor (block peg support 52). The three round pegs 48 are securely affixed to the outside of the inner vessel 22 bottom. Each peg 48 may be located 120 degrees apart along a circle centered on the vertical axis 26 of the inner vessel 22. Each of the round pegs 48 is mated with a female block peg support 52 that is securely affixed to the inner bottom of outer vessel 12 and spaced so that each peg support 52 can mate with the respective peg 48. This bottom-support component arrangement does not provide constraint on the vertical movement of the inner vessel 22. The corresponding side-support component of the mechanical support system must provide adequate such constraints.

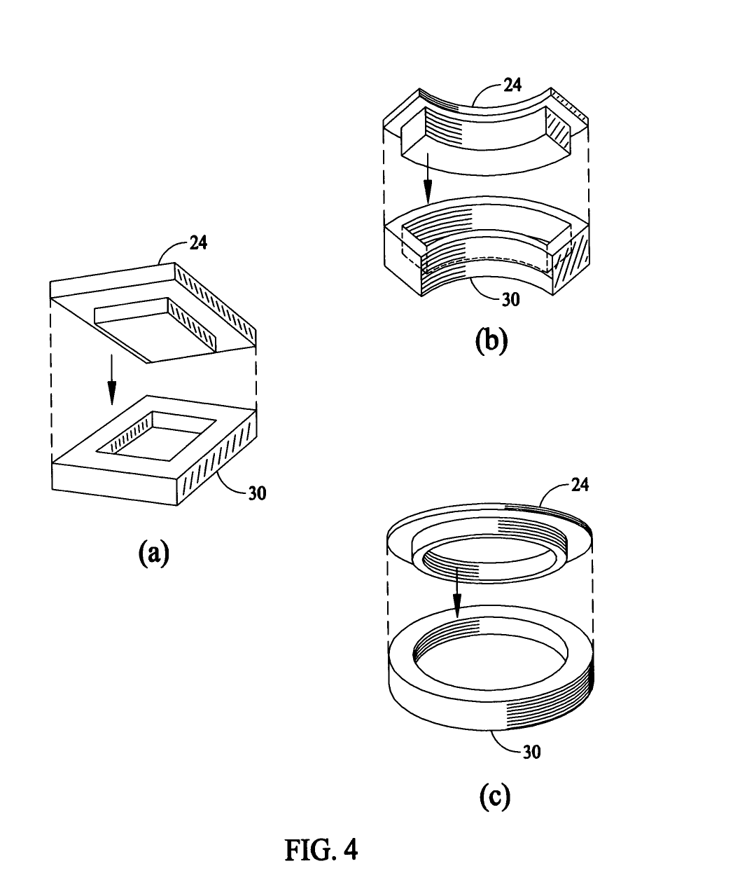

FIG. 4 is an illustration of various alternative configurations of the mating structure that may be utilized to form the bottom-support component of present invention. FIG. 4a is a square mating structure with male adapter 24 mates with a square female receptor 30. Only a single such mating structure is needed to adequately constrain inner vessel 22 movements in rotational, horizontal and lateral degrees of freedom, even though within the scope of present invention more than one such structure may be employed for redundancy or other reasons. FIG. 4b shows an arc-shaped mating structure for the bottom-support component of present invention. More than one of such structures may be employed for stability and other reasons on the bottom of the inner vessel 22. Finally, FIG. 4c shows a ring-type mating structure. Even though only one such structure is needed to provide horizontal and lateral constraints, more than one of such structure (three for stability concern) would be needed in order to constrain the rotational movement of the inner vessel 22.

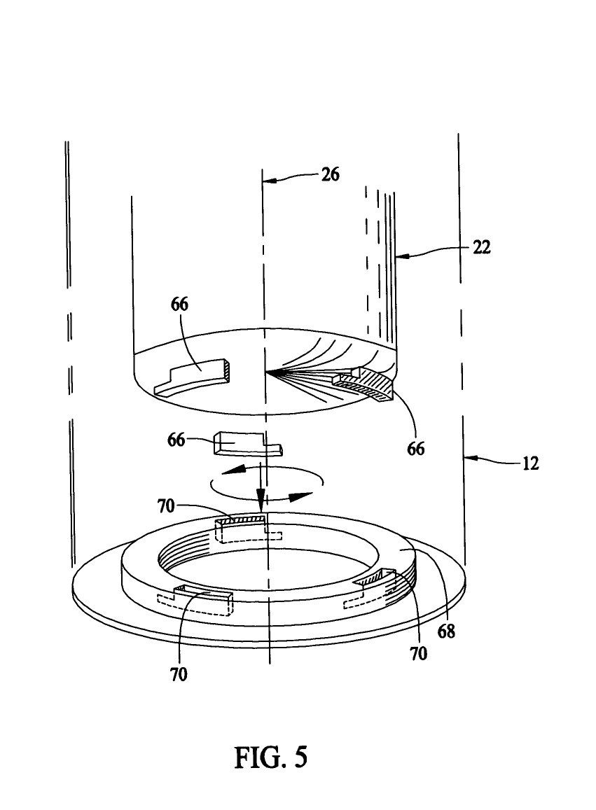

FIG. 5 illustrates another embodiment of bottom-support component of the present invention, the so-called “Twist-N-Lock” mechanism. In this configuration, three “L”-shaped mating structures form the bottom-support component of the mechanical support system. A male “L”-shaped lock support adapter 66 is securely affixed to the outside of the inner vessel 22 bottom. A ring-type structure 68 having three “L”-shaped female lock receptacles 70 is adapted to receive each respective male “L”-shaped lock support adapter 66. The ring-structure is securely affixed to the inside bottom of the outer vessel 12 and enables the male “L”-shaped lock support 66 to secure and be “locked” in place by rotational (clockwise shown) “twist” movement about the central vertical axis 26. Once the “L” locks are in place, the vertical movement of the inner vessel 22 is effectively constrained. This so-called “Twist-N-Lock” mechanism also provides horizontal and lateral constraints in addition to the (clockwise) rotational constraint. The inner vessel 22 can be “unlocked” if it is rotated counter clockwise (about the center axis 26) to its “unlock” position. There obviously can be many different alterations to this particular configuration of the bottom-support component of present invention. For example, the “L”-shaped mating structure can be rotated clockwise about its own approximate center vertical axis for 90 degree, 180 degree or 270 degree. In addition, other than three such mating structures can be utilized for such a bottom-support component.

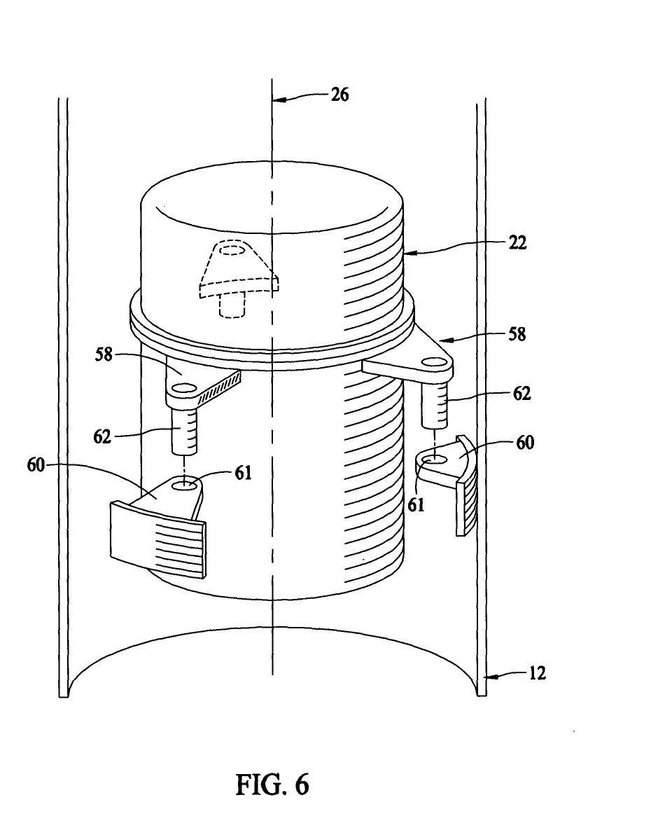

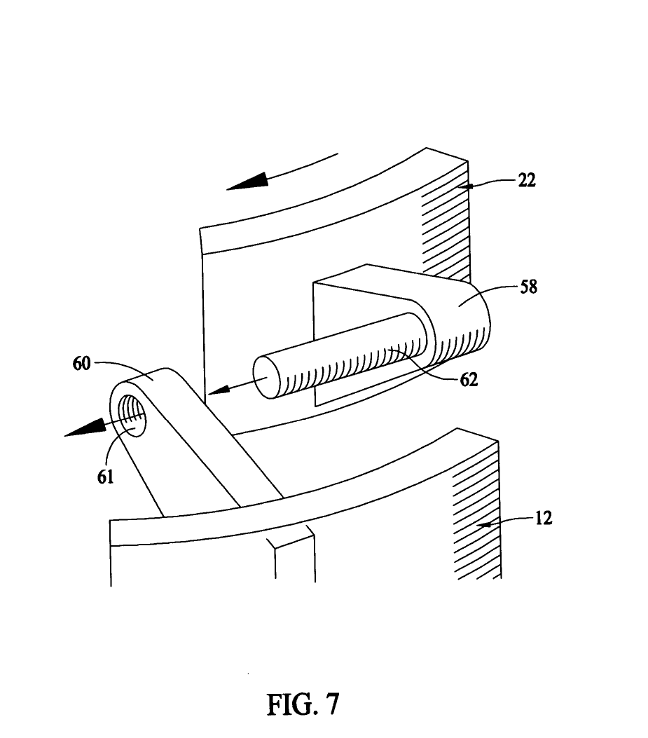

FIG. 6 illustrates one embodiment of the side-support component of the present invention. In this example, three mating structures are utilized to form the side-support component. They are disposed at 120-degree interval along the circumference of the inner 22 and outer 12 vessels. Each mating structure comprises one male adapter 58 that is securely affixed to the outside of the inner vessel 22 side wall, and one female receptor 60 that is securely mounted on the inside of the outer vessel 12 side wall. They are mated once the inner vessel 22 is vertically placed into the outer vessel 12 along the central vertical axis 26, after which a fastening mechanism is deployed on the pin-like leg 62 of the male adapter 58 to provide constraint on vertical movement of the inner vessel 22. The slot 61 (round, rectangular, etc.) on the female receptor 60 should be sufficiently larger than the pin-like leg 62 of the male adapter 58 to allow radial thermal contraction (towards the center axis 26) when the inner vessel 22 becomes cold. The mating structure shown in FIG. 6 can also be interpreted as a three-element-structure in that element 58 and element 60 are two female receptors that are mounted on the inner and outer vessel individually while element 62 is a pin-like structure that is not attached to either receptor. The pin-like structure 62 is used to “connect” the two female receptors 58 and 60 once they are aligned in place. There can be fastening mechanism to secure the vessels from vertical movement from each other. There are many different alterations to the embodiment in FIG. 6 discussed above. For example, other than three of the shown mating structures can be used to form the side-support component of present invention. The position of the male and female element of the mating structure can be reversed. FIG. 7 shows an illustration of turning the mating structure 90 degree side way. Again, the slot 61 size on the female receptor 60 (as well as the female receptor 58 for a three-element mating structure) should be sufficiently larger than the leg 62 of the male adapter 58 (or the connecting pin 62 in a three-element mating structure). The arrangement in FIG. 7 is well suited for the “Twist-N-Lock” bottom-support mechanism described earlier with regard to FIG. 5, since it will provide the vertical movement constraint on the inner vessel 22 once the vessels are locked in place at the bottom. A further fastening mechanism can then be employed to secure the leg/pin 62 to the female receptor 60 to prevent the inner vessel 22 from rotational (counter-clockwise in the example shown) movement.

The different configurations of the bottom-support component and the side-support component described herein can be utilized to form different embodiments of the mechanical support apparatus of present invention. They can be mixed and matched based on the number and/or type of degrees of freedom one wants to be constrained using such an apparatus. As such, any embodiments using different combinations of the configurations described herein are within the scope of the present invention.

The described embodiments of the present invention have many advantages, including preventing horizontal, lateral, vertical and rotational movements of inner vessel relative to the outer vessel, and minimizing the physical contact between the outer and the inner vessel to minimize heat leak into the cryogenic system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for securing an inner vessel having a bottom and a side wall and an outer vessel having a bottom wall and a side wall, within a cryogenic system, said inner vessel adapted to be enveloped by said outer vessel, wherein a vacuum may be maintained between the outer vessel and the inner vessel, said apparatus comprising:
at least one bottom-support component having at least one mating structure;
wherein said mating structure comprises at least one mating pair of one male-adapter and one female-receptor;
wherein one part of said mating pair is secured to the bottom of inner vessel while the other part of said mating pair is secured to the inner bottom of the outer vessel;
wherein said bottom-support component is adapted to hold the inner vessel at a positon eleveated from the inner bottom of the outer vessel;
wherein the inner vessel is prevented by said bottom-support component from horizontal and lateral movements.

2. The apparatus as recited in claim 1, further comprising at least one side-support component:
wherein said side-support component comprises at least one mating structure;
wherein said mating structure comprises at least one mating pair of one male-adapter and one female-receptor;
wherein one part of said mating pair is secured to the outer side wall of the inner vessel while the other part of said mating pair is secured to the inner side wall of the outer vessel;
wherein a fastening mechanism is employed to prevent relative rotational movements of the two parts of said mating pair, about a vertical axis near the geometric center of the outer vessel; and
wherein the inner vessel is prevented by said fastened side-support component from rotational movements about a vertical axis near the geometric center of the outer vessel.

3. The apparatus as recited in claim 1, further comprising at least one side-support component:
wherein said side-support component comprises at least one mating structure;
wherein said mating structure comprises two female receptor parts and one connecting pin-like element;
wherein one female receptor part of said mating structure is secured to the outer side wall of the inner vessel while the other female receptor part of said side-support mating structure is secured to the inner side wall of the outer vessel;
wherein a fastening mechanism is employed to secure at least one end of the connecting pin-like element of said side-support mating structure to prevent relative rotational movements of the two female receptor parts of said side-support mating structure, about a vertical axis near the geometric center of the outer vessel;
wherein the inner vessel is prevented by said fastened side-support mating structure from rotational movements about a vertical axis near the geometric center of the outer vessel.

4. The apparatus as recited in claim 1, wherein the cryogenic system is a high-temperature superconductor device system.

5. The apparatus as recited in claim 1, wherein the cryogenic system uses liquid nitrogen as the main cooling medium.

6. The apparatus as recited in claim 1, wherein said bottom-support mating structure has at least one part that is selected from a group consisting of a round peg, an arch peg, a ring peg, and a square peg.

7. The apparatus as recited in claim 1, wherein said bottom-support mating structure has at least one “L”-shaped leg for locking with the other part of the said bottom-support mating strucute, to prevent vertical movement of the inner vessel along a vertical axis near the geometic center of the outer vessel after the inner vessel is secured by said “L”-shaped bottom-support mating structure.

8. An apparatus for securing an inner vessel and an outer vessel, within a cryogenic system, the inner vessel adapted to be enveloped by the outer vessel, wherein a vacuum may be maintained between the outer vessel and the inner vessel, said apparatus comprising:
mating structure means for preventing rotational movement of the inner vessel about a vertical axis with repect to the outer vessel; and
mating structure means for preventing axial movement of the inner vessel with respect to the outer vessel.

9. The apparatus as recited in claim 8, wherein said mating structure means is a round peg and coresponding round peg leg securing means.

10. The apparatus as recited in claim 8, wherein said mating structure means is a square peg and coresponding square peg leg securing means.

11. The apparatus as recited in claim 8, wherein said mating structure means is a “L”-shaped hook for locking with a respective leg mating strucute to prevent planer movement along the vertical axis after the inner vessel is secured to said leg mating means.

12. The apparatus as recited in claim 8, wherein said mating structure means is a pin-like locking strucure.

13. An apparatus for securing an inner vessel and an outer vessel, within a cryogenic system, the inner vessel adapted to be enveloped by the outer vessel, wherein a vacuum may be maintained between the outer vessel and the inner vessel, said apparatus comprising:
leg means for preventing rotational movement of said inner vessel about a vertical axis with repect to the outer vessel;
wherein said leg means is a an “L”-shaped hook for locking with a respective female locking strucute to prevent rotational movement in one direction about a vertical axis and to prevent planer movements perpendicular to the vertical axis after said inner vessel is secured to said leg mating means.

14. An apparatus for securing an inner vessel and an outer vessel, within a cryogenic system, the inner vessel adapted to be enveloped by the outer vessel, wherein a vacuum may be maintained between the outer vessel and the inner vessel, said apparatus comprising:
leg means for preventing rotational movement of said inner vessel about a vertical axis with repect to said outer vessel, wherein said leg means is a round peg and coresponding round peg leg securing means.

15. An apparatus for securing an inner vessel and an outer vessel, within a cryogenic system, the inner vessel adapted to be enveloped by the outer vessel, wherein a vacuum may be maintained between the outer vessel and the inner vessel, said apparatus comprising:
leg means for preventing rotational movement of said inner vessel about a vertical axis with repect to the outer vessel, wherein said leg means is a square peg and coresponding square peg leg securing means.
